(19) United States
(12) Patent Application Publication
(10) Pub. No.: US 2020/0234043 A1
(43) Pub. Date: Jul. 23, 2020

(54) UNMANNED AERIAL VEHICLE GROUND LEVEL INSPECTION SYSTEM

(71) Applicant: Honeywell International Inc., Morris Plaines, NJ (US)

(72) Inventors: Shyh Pyng Shue, Grapevine, TX (US); Chao Li, Shanghai (CN); Hugo Tou, Macao (CN)

(73) Assignee: Honeywell International Inc., Morris Plains, NJ (US)

(21) Appl. No.: 15/757,623

(22) PCT Filed: Oct. 13, 2017
(86) PCT No.: PCT/CN2017/106041

§ 371 Date: Mar. 5, 2018

(51) Int. Cl. G06K 9/00; G01C 11/06; H04N 5/33; G05D 1/00; B64C 39/02

(52) U.S. Cl. CPC G06K 9/00637; G01C 11/06; H04N 5/33; B64C 2201/127; B64C 39/024; G06K 2009/00644; G05D 1/0094

(57) ABSTRACT

A computing system obtains a first infrared image of the structure captured by a first unmanned aerial vehicle (UAV) at an image capture location. The image capture location is independent of the structure such that any change in a position of the structure does not change the image capture location. Additionally, the computing system obtains a second infrared image of the structure captured by the first UAV or a second UAV at the image capture location. The computing system determines, based on an angle between the beam from the laser as shown in the first image and the beam from the laser as shown in the second image, a score for the second infrared image. The computing system determines, based on the score for the second infrared image, whether a position of the structure has changed during a time interval between capture of the first infrared image and capture of the second infrared image.

### TECHNICAL FIELD

This disclosure relates to systems for inspection of structures.

### BACKGROUND

Earthquakes, soil subsidence, ground slumping, water seepage, groundwater extraction, sinkhole development, tunneling, and other natural or artificial phenomena may cause the ground beneath a structure to change. Ground level changes are a frequent cause of structural collapse. For instance, changes in the ground level underneath a dam may indicate that the dam is at risk of failing.

However, changes in ground level are challenging to detect. For instance, it may be difficult to determine changes in the ground level of a structure because the ground from which an observation of the structure is taken may also have changed. For instance, it may be difficult to determine whether a structure has sunk or an observation station has risen.

### SUMMARY

In general, this disclosure relates to systems for detecting changes in positions of structures due to ground level changes. As described herein, lasers are attached to a structure at fixed positions. An unmanned aerial vehicle (UAV) captures a first set of images of the structure from various image capture locations. Images in the first set of images reveal paths of laser beams emitted by the lasers attached to the structure. Subsequently, the UAV returns to the same image capture locations and captures a new set of images revealing the paths of the laser beams emitted by the lasers attached to the structure. Because the UAV is airborne, the image capture locations are the same regardless of whether the ground level below the UAV has changed. By comparing angles of the laser beams in the first and second sets of images, a computing system may determine whether a position of the structure has changed during a time interval between when the UAV captured the first set of images and when the UAV captured the second set of images.

In one example, this disclosure describes a method for detecting a position change of a structure, the method comprising: obtaining, by a computing system, a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image; obtaining, by the computing system, a second infrared image of the structure captured by the first UAV or a second UAV at the image capture location after the first infrared image was captured, wherein the beam of the laser is represented in the second infrared image; determining, by the computing system, based on an angle between the beam from the laser as shown in the first image and the beam from the laser as shown in the second image, a score for the second infrared image; determining, by the computing system, based on the score for the second infrared image, whether a position of the structure has changed during a time interval between capture of the first infrared image and capture of the second infrared image, wherein the laser remains attached to the structure during the time interval; and outputting, by the computing system, an indication of whether the position of the structure has changed during the time interval.

In another example, this disclosure describes a computing system comprising: a memory configured to: store a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image; store a second infrared image of the structure captured by the first UAV or a second UAV at the image capture location after the first infrared image was captured, wherein the beam of the laser is represented in the second infrared image; and one or more processing circuits configured to: determine, based on an angle between the beam from the laser as shown in the first image and the beam from the laser as shown in the second image, a score for the second infrared image; determine, based on the score for the second infrared image, whether a position of the structure has changed during a time interval between capture of the first infrared image and capture of the second infrared image, wherein the laser remains attached to the structure during the time interval; and output an indication of whether the position of the structure has changed during the time interval.

In another example, this disclosure describes a non-transitory computer-readable storage medium having instructions stored thereon that, when executed, cause a computing system to: obtain a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image; obtain a second infrared image of the structure captured by the first UAV or a second UAV at the image capture location after the first infrared image was captured, wherein the beam of the laser is represented in the second infrared image; determine, based on an angle between the beam from the laser as shown in the first image and the beam from the laser as shown in the second image, a score for the second infrared image; determine, based on the score for the second infrared image, whether a position of the structure has changed during a time interval between capture of the first infrared image and capture of the second infrared image, wherein the laser remains attached to the structure during the time interval; and output an indication of whether the position of the structure has changed during the time interval.

The details of one or more examples of the disclosure are set forth in the accompanying drawings and the description below. Other features, objects, and advantages will be apparent from the description, drawings, and claims.

### BRIEF DESCRIPTION OF THE DRAWINGS

FIG. 1 shows an example Unmanned Aerial Vehicle (UAV) system, which may be configured to implement the techniques of this disclosure.

FIG. 2 is a conceptual diagram illustrating an example structure and image capture locations, in accordance with a technique of this disclosure.

FIG. 3 is a block diagram illustrating example components of a UAV that may be used to implement techniques of this disclosure.

FIG. 4 is a block diagram illustrating example components of a computing system, in accordance with a technique of this disclosure.

FIG. 5A illustrates an example image of a bridge with attached lasers, in accordance with a technique of this disclosure.

FIG. 5B illustrates an example image of the bridge of FIG. 5A captured at a later time.

FIG. 6 illustrates an example building with attached lasers, in accordance with a technique of this disclosure.

FIG. 7 is a flowchart illustrating an example operation for detecting a position change of a structure, in accordance with a technique of this disclosure.

FIG. 8 is a conceptual diagram illustrating a technique for comparing pictures, in accordance with a technique of this disclosure.

FIG. 9 illustrates a decision chart for ground-level movements, in accordance with a technique of this disclosure.

### DETAILED DESCRIPTION

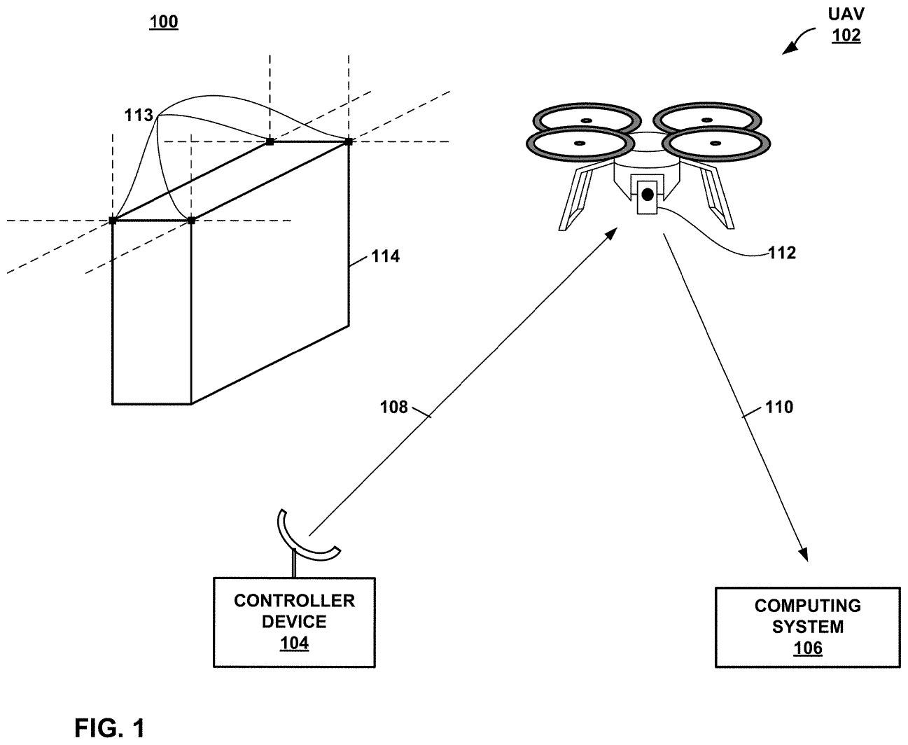

FIG. 1 shows an example of an Unmanned Aerial Vehicle (UAV) system 100, which may be configured to implement the techniques of this disclosure. UAV system 100 includes a UAV 102, a controller device 104, and a computing system 106. In UAV system 100, controller device 104 controls a flight path and data gathering functions of UAV 102. Computing system 106 processes the data collected by UAV 102. Although shown as separate devices in FIG. 1, in some UAV systems, the functionality of controller device 104 and computing system 106 may be performed by a common device.

UAV 102 is shown in FIG. 1 as a quadcopter, but UAV 102 may be any type of UAV including, but not limited to, a rotorcraft, a fixed wing aircraft, compound aircraft such as tilt-rotor, X2 and X3, an aerostat, or any other such type of UAV including all vertical take-off and landing (VTOL), tail-sitter, etc. UAV 102 may be configured to fly with various degrees of autonomy. In some examples, UAV 102 may be under the constant, or near constant, control of a user of controller device 104. In other examples, controller device 104 may deliver a mission, including a flight plan, to UAV 102, and onboard processing circuitry of UAV 102 may be configured to execute the mission, with little or no additional user input. In some examples, UAV 102 may use LIDAR for collision avoidance.

Although the techniques of this disclosure are not limited to any particular type of UAV, UAV 102 may, for example, be a relatively small, low altitude, and low speed UAV, where in this context, small corresponds to under 100 lbs, low altitude corresponds to operating altitudes less than 3000 feet above ground, and low air speed corresponds to air speeds less than 250 knots. Furthermore, it is contemplated that UAV 102 may have hovering capabilities, meaning UAV 102 may have the capability of remaining at an approximately constant location in the air.

In some examples, controller device 104 comprises a general-purpose device such as a personal digital assistant (PDA), a laptop or desktop computer, a tablet computer, a cellular or satellite radio telephone, a “smart phone,” or another such device. In examples where controller device 104 is a general-purpose device, controller device 104 may be loaded with and configured to execute software designed to control UAV 102. In other examples, controller device 104 is a special-purpose device designed specifically for use in controlling UAV 102.

Controller device 104 communicates with UAV 102 via communication link 108. Communication link 108 may, for example, be a direct link through a radio communication protocol, such as WiFi, Bluetooth, ZigBee, a proprietary protocol, or any other suitable protocol. In other examples, communication link 108 may be a network-based link where controller device 104 communicates with UAV 102 through one or more intermediary devices such as gateways, routers, switches, repeaters, or other such network devices.

Computing system 106 comprises one or more computing devices. For example, computing system 106 may comprise a general-purpose device, such as a personal digital assistant (PDA), a laptop or desktop computer, a tablet computer, a smart phone, a server device, or another such device. Computing system 106 may be loaded with and configured to execute software designed to process data collected by UAV 102. In some examples, UAV 102 is configured to stream data to computing system 106 in real-time or near real time via, for example, a wireless communication link 110. In other examples, UAV 102 stores data while in flight and transfers the data to computing system 106 at a later time, such as after the completion of a flight.

One or more cameras 112 are mounted on UAV 102. In accordance with a technique of this disclosure, cameras 112 may include one or more cameras capable of capturing images of infrared radiation. Additionally, in some examples of this disclosure, cameras 112 may include one or more cameras capable of capturing images of visible light.

As shown in the example of FIG. 1, lasers 113 are attached to a structure 114. Although illustrated in FIG. 1 as having a rectangular block shape, structure 114 may have many forms. For example, structure 114 may be a building, a dam, a solar panel array, a wind turbine, a monument, a bridge, a levee, a seawall, a pier, an antenna, a volcano, a pump station, or another type of artificial or natural structure. The number of lasers 113 attached to structure 114 may be arbitrary. In some examples, to ensure accuracy of ground level inspection, there may be at least three lasers whose beams are oriented on x, y, and z inspection axes. In this disclosure, the x axis may correspond to a longitudinal direction, the y axis may correspond to a lateral direction, and the z axis may correspond to a vertical direction. Use of too many lasers may increase inspection time and may result in an excess number of images being captured and stored. However, use of too few lasers may diminish inspection accuracy.

The lasers 113 attached to structure 114 emit laser beams of infrared radiation. In the example of FIG. 1, the laser beams are represented as dashed lines. Because the laser beams heat the air the laser beams pass through, the air along the paths of the laser beams emits infrared radiation. Infrared images captured by cameras 112 mounted on UAV 102 may therefore reveal the paths of the laser beams. During or after installation of lasers 113, a technician may calibrate lasers 113. For example, to calibrate lasers 113, the technician may adjust the lasers to ensure that laser beams emitted by lasers 113 are parallel or orthogonal to a direction of gravity.

In accordance with a technique of this disclosure, UAV 102 flies to predetermined image capture locations. At each of the image capture locations, cameras 112 of UAV 102 capture one or more infrared images of structure 114, thereby capturing a first set of infrared images of structure 114. Each of the image capture locations may be defined in terms of x, y, and z coordinates. In some examples, UAV 102 saves the captured images on a Secure Digital (SD) card or other type of memory card, and may also transfer on-line to a cloud-based web server using 3G, 4G, 5D, Narrow Band-Internet of Things (NBIOT), or another wireless type of transmission technologies. In some examples, UAV 102 is equipped with one or more differential Global Navigation Satellite System (GNSS) devices to assist UAV 102 navigate to the image capture locations. For instance, UAV 102 may be equipped for real-time kinematics, which is a type of differential GNSS that may provide high positioning performing for UAV 102 in the vicinity of a base station. In some examples, accuracy of the GNSS devices may be within 1 centimeter.

The first set of infrared images may show the paths of the laser beams emitted from lasers 113 attached to structure 114. Computing system 106 stores the first set of captured infrared images for later analysis. Cameras 112 of UAV 102 may also capture a first set of visible-light images of structure 114 at the image capture locations, which may be associated with the same GNSS position. Computing system 106 may also store the first set of captured visible light images for later analysis.

Subsequently, UAV 102 returns to the same predetermined image capture locations and captures a second set of infrared images of structure 114. Computing system 106 may store the second set of infrared images for later analysis. Cameras 112 of UAV 102 may also capture a second set of visible light images of structure 114 at the image capture locations. Computing system 106 may also store the second set of captured visible-light images for later analysis.

In various examples, UAV 102 captures a second set of images after various time periods have elapsed or after various events have occurred. For example, UAV 102 may capture sets of images monthly, yearly, or after some other time period has elapsed. In some examples, UAV 102 captures a set of images after an event such as an earthquake or tunneling activity has occurred.

The predetermined image capture locations are not dependent on the ground level directly below the predetermined image capture locations. For instance, the ground directly below one of the predetermined image capture locations may rise or fall without changing the predetermined image capture location. In this disclosure, corresponding images are images captured from the same image capture location. In other words, two images captured from the same image capture location are deemed corresponding images.

For each respective infrared image of the second set of infrared images, computing system 106 attempts to identify a corresponding image in the first set of infrared images. The corresponding infrared image may be captured from the same image capture location as the infrared image in the second set of infrared images. Computing system 106 may identify a corresponding image in various ways. For example, computing system 106 may receive image capture location coordinates (e.g., coordinates in x, y, and z dimensions) for each image. The image capture location coordinates for an image indicate coordinates of UAV 102 when camera 112 captured the image. In this example, computing system 106 may determine that one image corresponds to another image based on the images being associated with the same image capture location coordinates.

Computing system 106 compares infrared images in the first set of infrared images to corresponding infrared images in the second set of infrared images. For example, computing system 106 may compare the angles of laser beams in the corresponding infrared images. Changes in the angles of laser beams may indicate that the ground beneath the structure shown in the images has shifted. For example, if a laser beam was at 0° in the first infrared image and the same laser beam was at 5° in the second infrared image, the ground level under the structure may have shifted up or down.

In some examples, computing system 106 may also or alternatively compare relative angles between two or more different laser beams. For example, a set of two or more lasers may initially emit parallel laser beams in a given direction. Each of the parallel laser beams may be termed a separate “layer.” In this example, computing system 106 may determine whether the laser beams remain parallel, within a tolerance limit, in the second set of infrared images. The laser beams no longer being parallel is an indication that a position of the structure may have shifted.

Furthermore, in some examples, a pair of lasers attached to a structure may initially emit orthogonal laser beams. For instance, one of the lasers may emit a vertical laser beam and another one of the lasers may emit a horizontal laser beam. In another instance, two lasers may emit laser beams that are horizontal relative to ground level, but are orthogonal to each other. In such examples, computing system 106 may determine whether the laser beams remain orthogonal, within a tolerance limit, in the second set of infrared images. The laser beams no longer being orthogonal is an indication that a position of the structure may have shifted.

Additionally, computing system 106 may compare corresponding visible-light images to identify inspection targets. Example types of inspection targets may include cracks, spalling, warping or bending of structural elements, debris accumulations (e.g., dust, metal shavings, rust flakes, bird fecal matter), and so on. For instance, in an example where the structure is a bridge, comparison of visible-light images with the same image capture locations may determine whether there is damage to the bridge surface (e.g., concrete loss), whether the sizes of bridge connection gaps (e.g., thermal expansion joints) are correct, whether bridge support points have changed distance, and so on. In some examples, computing system 106 may map visual-light images (which are associated with particular image capture locations in (x, y, z) space) to 2-D and/or 3-D models of a structure. Thus, in some examples, computing system 106 may associate individual features, such as corners, of the structure with visual-light images. This may allow computing system 106 and/or a user to identify and store data indicating positions in the structure that need maintenance or repair.

In some examples, computing system 106 retrieves (e.g., automatically, in response to user input, etc.) visible-light images corresponding to infrared images in response to computing system 106 determining, based on a comparison of the infrared images, that a position of the structure has changed during the time interval. A user may use the retrieved visible-light images to perform further inspection of the structure and to identify inspection targets. For instance, in the case where the structure comprises a set of solar panels, a user may use the visible-light images to identify cracking or jamming of the solar panels. Use of the visible-light images may help the user verify that the results of the analysis of the infrared images and may help identify positions of damaged surfaces for the purpose of maintenance and repair. In some examples, a user may use the visible-light images to determine maintenance or repair requirements in materials, processes, procedures, schedule estimate, and issuance of work orders.

In some examples, computing system 106 generates a score for an image based on a comparison of the image with a historical image. This disclosure may refer to the score for an image as an out-of-phase score, as the score may be a measure of the difference between the position of the structure as shown in the image and in the historical image. In some examples, computing system 106 may determine the out-of-phase score for an infrared image such that the out-of-phase score for the infrared image is proportional to an angle between a baseline and a laser line as shown in the image. For instance, higher out-of-phase scores may correspond to higher angles. Computing system 106 or a user may classify a visible-light image as out-of-phase if the visible-light image shows visible signs that the structure is in need of maintenance, repair, or is out-of-specification.

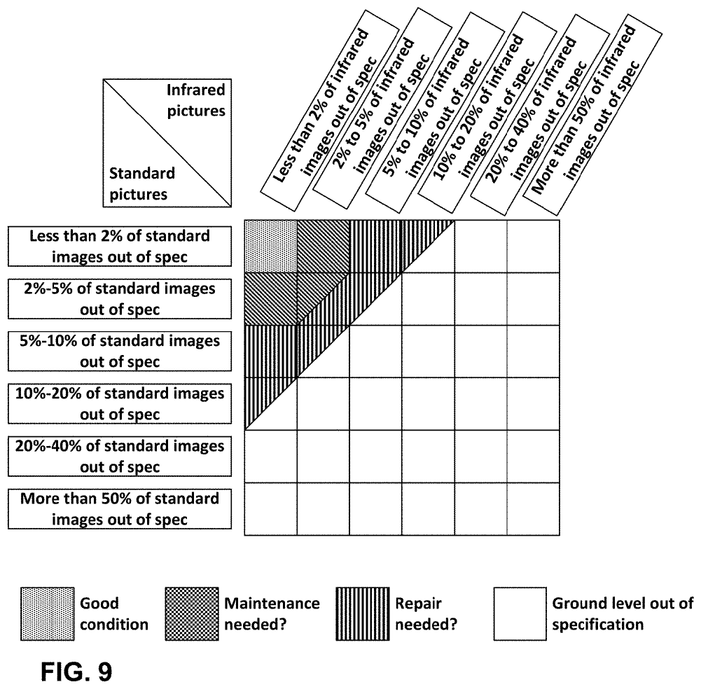

Computing system 106 may also determine a total score for the structure based on the images. The total score may be used to assess whether trigger points have been reached for conducting maintenance on the structure, repairs to the structure, or whether the structure must be evacuated or condemned. In some examples, to determine the total score, computing system 106 may determine the total score for the structure as the percentage of images in a set of images (e.g., the second set of infrared images described above) having out-of-phase scores greater than a particular threshold. For instance, in one example, computing system 106 may rank images in a set of images according to their respective out-of-phase scores (e.g., in descending order or ascending order). A cumulative alert score curve is a curve in a chart mapping the ranked images to their out-of-phase scores. In this example, after ranking the images, computing system 106 may determine the percentage of images having out-of-phase scores that fall into a most severe category. In this example, this percentage may be the total score for the structure. Images having out-of-phase scores in the most severe category are referred to as out-of-spec images. FIG. 9, discussed in detail below, illustrates another example of how to determine whether trigger points have been reached for conducting maintenance on the structure, repairs to the structure, or whether the structure must be evacuated or condemned.

In some examples, computing system 106 adjusts images to correct for yaw, attitude, and tilt differences between the images and historical images. In some examples, UAV 102 includes various sensors to detect an inflight orientation of UAV 102. Such sensors may include a compass and/or gyroscope to detect yaw, gyroscopes to detect attitude and tilt, and so on. UAV 102 may send orientation data for each image in a historical set of images, such as the first set of infrared images discussed above. For example, the orientation data for a first image in the historical set of images may indicate that UAV 102 was tilted 2° when a camera mounted on UAV 102 captured the image. In this example, the orientation data for a second image (e.g., an image in the second set of infrared images) may indicate that UAV 102 was tilted 5° when the camera mounted on UAV 102 captured the second image. Furthermore, in this example, computing system 106 may rotate the second image −3° to align the first image and the second image. In this way, the first and second images may be aligned. In other examples, computing system 106 may apply skew effects to pictures to compensate for yaw and attitude differences. Computing system 106 may receive perform similar processes for both infrared and visible-light images.

Computing system 106 may also perform various other types of pre-treatment on the images. For example, computing system 106 may apply various filters to the images (e.g., to increase contrast, reduce noise, and so on. In some examples, computing system 106 may zoom in or zoom out the images for consistent view. In some examples, computing system 106 may amplify other special characteristics in the images. For example, various environmental conditions, such as bright skies, cloudy skies, rain, fog, and so on, may affect the quality of infrared and visible light images captured by UAV 102. Additionally, wind may cause UAV 102 to vibrate, potentially resulting in blurred images. Computing system 106 may apply various effects to images to compensate for environmental conditions. For example, computing system 106 may apply filters to remove blur and may zoom in or zoom out. For infrared images, computing system 106 may add a contrast color factor to emphasize and clarify the laser lines.

In some examples, computing system 106 superimposes infrared images with contemporaneous visible-light images. For instance, computing system 106 may use control surfaces to apply a colored layer mask to a visible-light image to superimpose a corresponding infrared image on the visible-light image. The control surfaces may include identifiable landmarks in the images that can be used to match up corresponding positions in the visible-light image and the infrared image. For example, UAV 102 may concurrently capture an infrared image and a visible-light image. In this example, computing system 106 may superimpose the infrared image onto the visible-light image such that the resulting image shows laser beams emitted by lasers attached to a structure and also an ordinary visible light image of the structure.

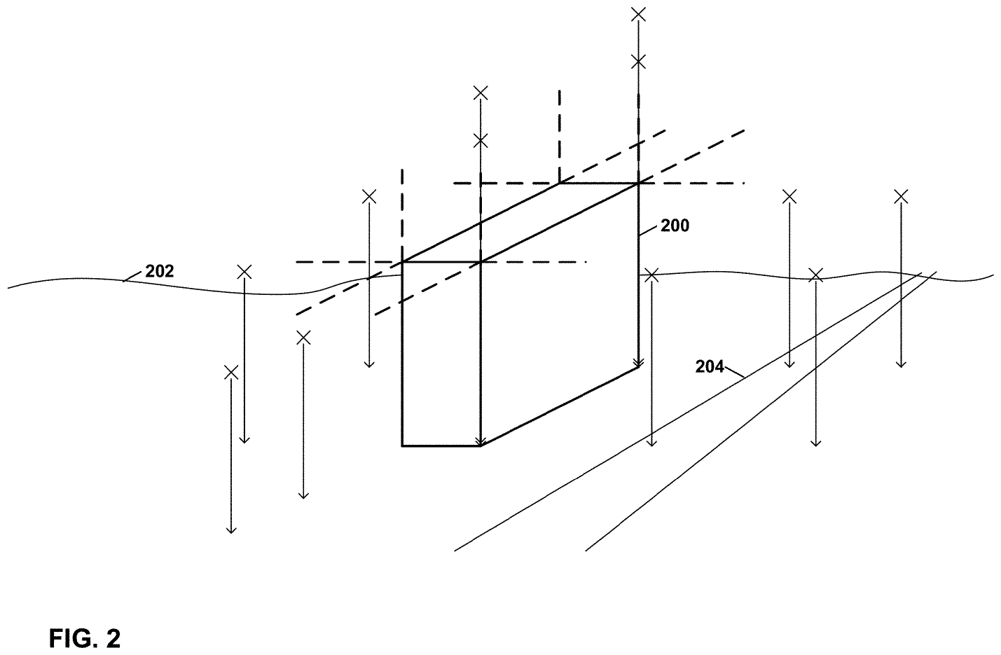

FIG. 2 is a conceptual diagram illustrating an example structure and image capture locations, in accordance with a technique of this disclosure. In the example of FIG. 2, lasers are attached to a structure 200. A horizon 202 is shown in the background and a road 204 runs toward horizon 202. Beams of the lasers are shown in FIG. 2 as dashed lines. Image capture locations are shown in FIG. 2 as “X” marks. The arrows below the “X” marks indicate locations on the ground directly beneath the image captures locations.

A UAV, such as UAV 102 (FIG. 1), may capture images at each of the image capture locations. As shown in the example of FIG. 2, the image capture locations may include image capture locations aligned with each other closer and further from structure 200.

In general, to capture 3-dimensional movement of structure 200, there may need to be a minimum of two image capture locations. The image capture locations may be separated from each other by 90° in a horizontal plane (i.e., a plane orthogonal to a gravity vector).

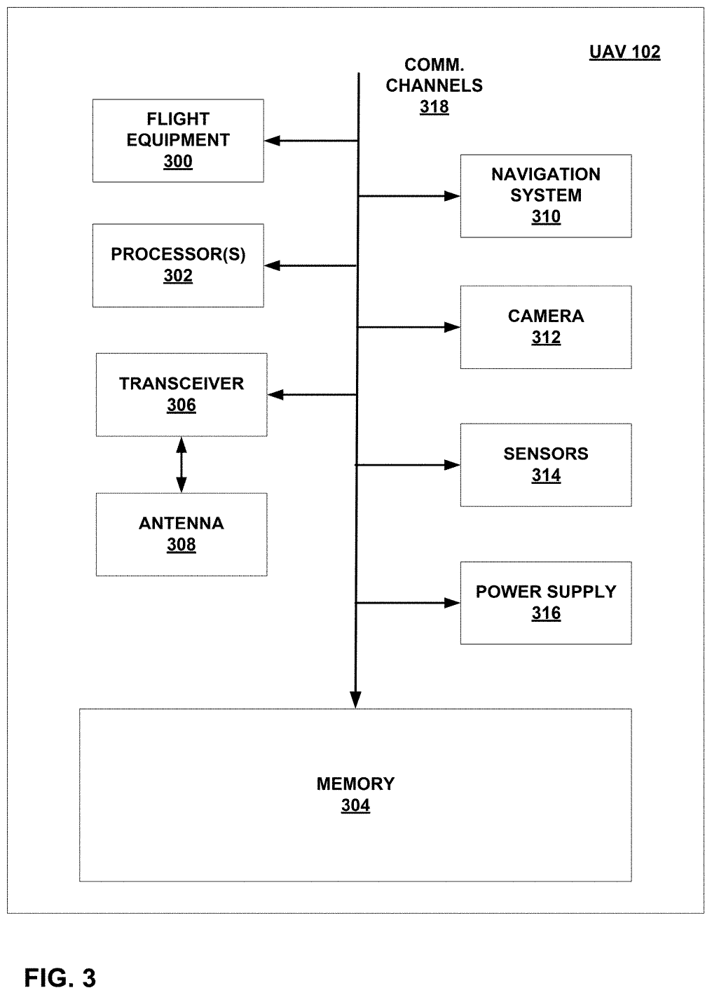

FIG. 3 shows an example illustration of UAV 102. UAV 102 includes flight equipment 300, processor 302, memory 304, transceiver 306, antenna 308, navigation system 310, camera 312, sensor 314, and power supply 316. Communication channels 318 interconnect each of flight equipment 300, processor 302, memory 304, transceiver 306, antenna 308, navigation system 310, camera 312, sensor 314, and power supply 316 for inter-component communications (physically, communicatively, and/or operatively). In some examples, communication channels 318 include a system bus, a network connection, an inter-process communication data structure, or any other method for communicating data, including various types of wireless communication technologies. Power supply 316 may provide electrical energy to each of the other components of UAV 102. In some examples, power supply 316 is a battery.

Processor 302 is intended to represent all processing circuitry and all processing capabilities of UAV 102. Processor 302 may, for example, include one or more digital signal processors (DSPs), general purpose microprocessors, integrated circuits (ICs) or a set of ICs (e.g., a chip set), application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Memory 304 is intended to represent all of the various memory devices within UAV 102. Memory 304 constitutes a computer-readable storage medium and may take the form of either a volatile memory that does not maintain stored contents once UAV 102 is turned off or a non-volatile memory that stores contents for longer periods of time, including periods of time when UAV 102 is an unpowered state. Examples of volatile memories include random access memories (RAM), dynamic random access memories (DRAM), static random access memories (SRAM), integrated random access memory (IRAM), thyristor random access memory (TRAM), zero-capacitor random access memory (ZRAM), or any other type of suitable volatile memory. Examples of non-volatile memory include optical disk drives, magnetic disk drives, flash memory, read only memory (ROM), forms of electrically programmable memories (EPROM) or electrically erasable and programmable memories (EEPROM), or any other such type of non-volatile memory.

The functionality of UAV 102 is implemented by hardware, software, firmware, or combinations thereof. Memory 304 may store software and firmware that include sets of instructions. Processor 302 and, other hardware components of UAV 102, may execute the instructions to perform the techniques of this disclosure.

Transceiver 306 is configured to send and receive data using antenna 308. Transceiver 306 may send and receive data according to any of the wireless communication protocols described elsewhere in this disclosure. For example, transceiver 306 may be configured to receive navigation instructions. Additionally, transceiver 306 may be configured to send images and other data to a computing system, such as controller device 104 (FIG. 1) or computing system 106 (FIG. 1).

Navigation system 310 controls a flight path of UAV 102. For example, navigation system 310 may output signals to flight equipment 300 to instruct UAV 102 to fly to predetermined image capture locations, to land, or to otherwise navigate to locations along a flight path of UAV 102.

Camera 312 is configured to capture infrared images. Additionally, in some examples, camera 312 is configured to capture visible light images. In some examples, the same camera captures both infrared images and visible light images. In other examples, UAV 102 has separate cameras to capture infrared images and visible light images. Processors 302 may be configured to control camera 312.

Sensor 314 are intended to represent all the various sensors included in UAV 102. UAV 102 may, for example, include one or more sensors used for flight management, such as accelerometers, gyroscopes, magnetometers, barometers, GNSS sensors, tilt sensors, inertial measurement sensors, speed sensors, and others.

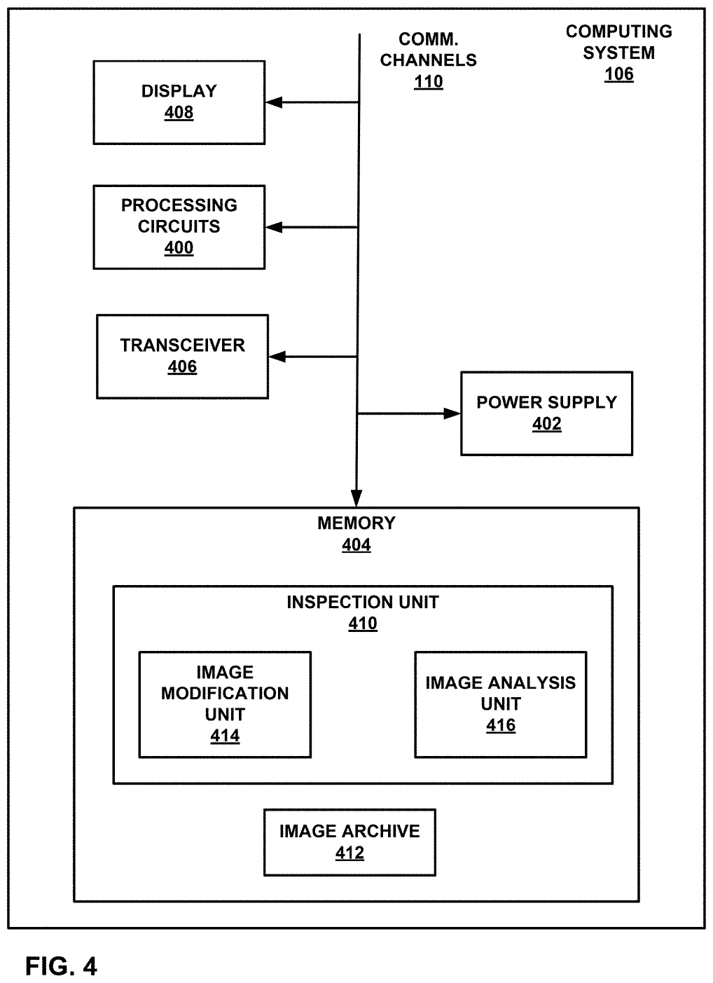

FIG. 4 is a block diagram illustrating example components of computing system 106, in accordance with one or more techniques of this disclosure. In the example of FIG. 4, computing system 106 includes one or more processing circuits 400, power supply 402, memory 404, transceiver 406, a display 408. Communication channels 110 interconnect processing circuits 400, memory 404, transceiver 406, and display 408. Power supply 402 provides power to processing circuits 400, memory 404, transceiver 406 and display 408. Processing circuits 400, memory 404, transceiver 406, and display 408 may be implemented in a manner similar to processing circuits 302, memory 304, and transceiver 306 described above with respect to FIG. 3. Display 408 may comprise various types of displays for outputting data, such as liquid crystal displays, plasma displays, light emitting diode (LED) displays, and so on.

In the example of FIG. 4, memory 404 stores an inspection unit 410 and an image archive 412. Furthermore, as shown in the example of FIG. 4, inspection unit 410 comprises an image modification unit 414 and an image analysis unit 416. Inspection unit 410, image modification unit 414, and image analysis unit 416 may comprise instructions that, when executed by processing circuits 400, cause computing system 106 to perform actions ascribed in this disclosure to inspection unit 410, image modification unit 414, and image analysis unit 416.

In the example of FIG. 4, inspection unit 410 may configure transceiver 406 to receive data from UAV 102 (FIG. 1; FIG. 3). As a result, inspection unit 410 may receive various types of data from UAV 102. For example, inspection unit 410 may receive image data, orientation data, image capture location coordinate data, and other types of data from UAV 102. Thus, transceiver 406 may be configured to receive an image captured by a camera mounted on an UAV, where the image is of a structure.

In some examples, image modification unit 414 performs image pre-treatment functions to images. For example, image modification unit 414 may rotate or skew an image received from UAV 102 such that the image appears to be taken from the same angle as historical images captured at the same image capture location. For instance, if the historical images are all taken with a tilt of 0° relative to a plane orthogonal to a gravitational vector, but a gust of wind occurring when UAV 102 captured a new image caused the new image to be taken with a tilt of 5° relative to the plane, image modification unit 414 may rotate the new image −5° to ensure that the new image is from an angle consistent with the historical images. Similarly, historical images of the structure taken at a particular image capture location may be taken straight on at the structural bearing, but a camera of UAV 102 may be yawed or pitched 4° when taking a new image of the structure at the same image capture location. Accordingly, in this example, image modification unit 414 may apply a skew of −4° to the new image to correct for the yaw or pitch. Image modification unit 414 may determine the tilt, yaw, or pitch based on orientation data generated by UAV 102 at the times the images were captured.

Image analysis unit 416 may analyze images of a structure to determine whether the structure has changed positions. For example, image analysis unit 416 may obtain a first infrared image and a second infrared image taken at different times at the same image capture location. In this example, image analysis unit 416 may determine, based on an angle between the beam from the laser as shown in the first image and the beam from the laser as shown in the second image, a score for the second infrared image. Additionally, image analysis unit 416 may determine, based on the score for the second infrared image, whether a position of the structure has changed during a time interval between capture of the first infrared image and capture of the second infrared image, wherein the laser remains attached to the structure during the time interval. Furthermore, image analysis unit 416 may output an indication of whether the position of the structure has changed during the time interval.

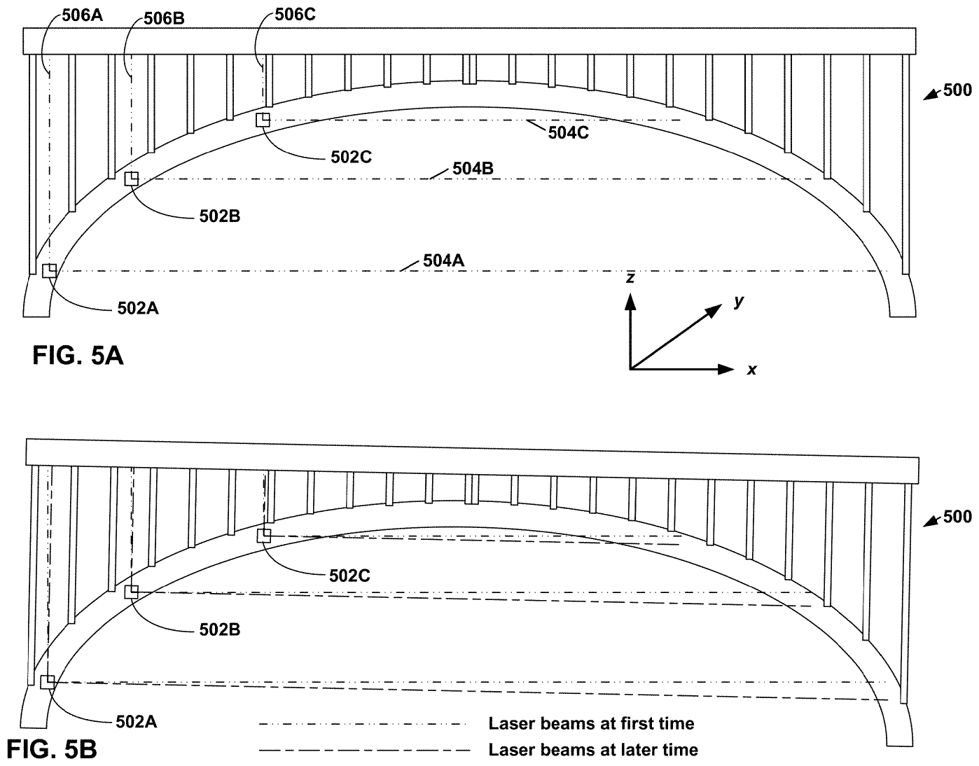

FIG. 5A illustrates an example image of a bridge 500 with attached lasers. In the example of FIG. 5A, lasers 502A-502C (collectively, “lasers 502”) are attached to bridge 500. Each of lasers 502 emits a vertical laser beam and a horizontal laser beam. In the example of FIG. 5A, the laser beams are shown as dashed lines interspersed with two dots. Laser beams 504A, 504B, and 504C (collectively, “laser beams 504”) are initially parallel to each other. Thus, laser beams 504 may be considered different layers. Similarly, laser beams 506A, 506B, and 506C (collectively, “laser beams 506”) are initially parallel to each other. Laser beam 504A is orthogonal to laser beam 506A, laser beam 504B is orthogonal to laser beam 506B, and laser beam 504C is orthogonal to laser beam 506C. Laser beams 504 are directed along an x-axis and laser beams 506 are directed along a z-axis. Lasers that emit laser beams along a y-axis may also be mounted on bridge 500, but are omitted for the sake of clarity.

FIG. 5B illustrates an example image of bridge 500 of FIG. 5A captured at a later time. In the example of FIG. 5B, the ground beneath the right side of bridge 500 has subsided. As a result, the angles of the laser beams emitted by lasers 502 has changed relative to horizontal and vertical. In the example of FIG. 5B, the paths of the laser beams emitted by lasers 502 at the later time are shown as dashed lines interspersed with shorter dashes. The dashed lines interspersed with two dots shows the original paths of the laser beams in FIG. 5A for comparison. Computing system 106 may be able to determine that the laser beams emitted by lasers 502 are differently angled at the later time relative to the time of FIG. 5A.

Additionally, in some examples, computing system 106 may determine whether laser beams 504 remain parallel to one another in infrared images captured at the later time. Thus, in general, computing system 106 may determine, for each pair of laser beams directed along the x-axis, whether the pair of laser beams remain parallel to each other. Computing system 106 may also determine whether laser beams 506 remain parallel to one another in the infrared images captured at the later time. Thus, in general, computing system 106 may determine, for each pair of laser beams directed along the z-axis, whether the pair of laser beams remain parallel to each other. Computing system 106 may make a similar determination for pairs of laser beams directed along the y-axis. Thus, in general, for a first laser beam initially directed along a given axis (e.g., the x-axis, y-axis, or z-axis), computing system 106 may determine whether a second laser beam initially directed along the given axis remains parallel to the first laser beam.

In some examples, computing system 106 may determine whether laser beams 504 remain orthogonal to laser beams 506. For instance, laser beam 504A no longer being orthogonal to laser beam 506C may be an indication of cracking or twisting of bridge 500. In general, for a first laser beam initially directed along a first axis (e.g., the x-axis, y-axis, or z-axis), computing system 106 may determine whether a second laser beam initially directed along a second, orthogonal axis, remains orthogonal to the first laser beam.

Furthermore, in some examples, lasers are initially mounted on a structure such that laser beams emitted by the lasers are not orthogonal, but rather may have other relative angles, such as 25°, 45°, 65°, etc. Computing system 106 may perform a similar process to check whether the angles between the laser beams emitted from lasers so mounted remains consistent.

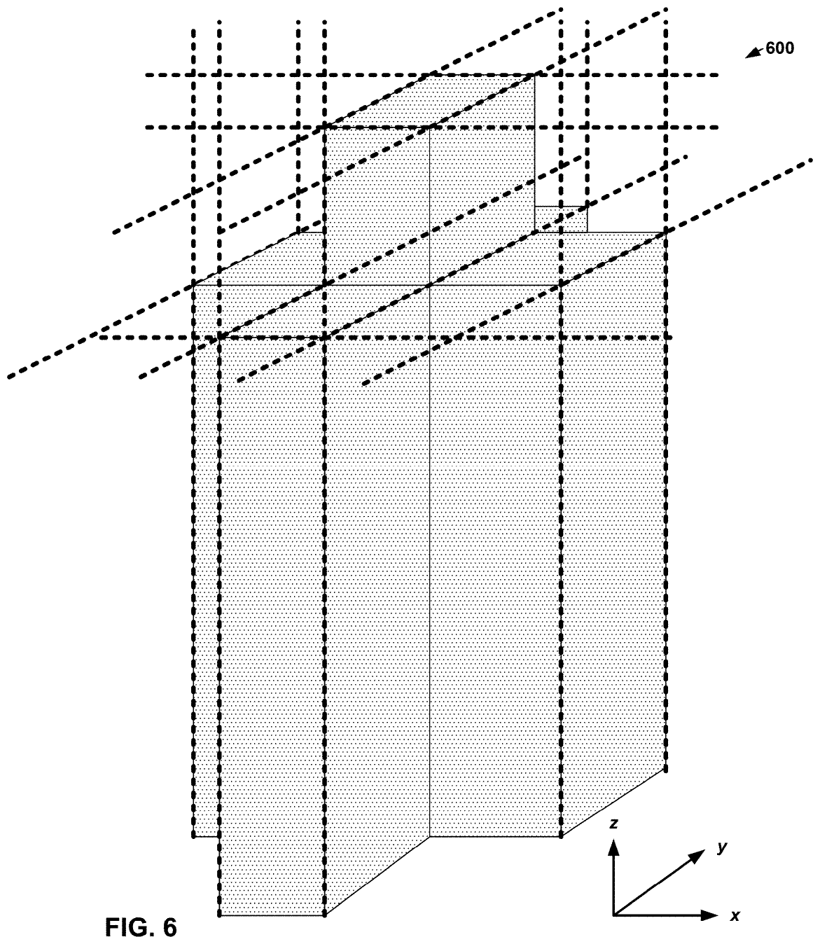

FIG. 6 illustrates an example building 600 with attached lasers, in accordance with a technique of this disclosure. In the example of FIG. 6, laser beams emitted by lasers attached to building 600 are shown as dashed lines. Based on the configuration of lasers attached to building 600, infrared images captured by a UAV at predetermined image capture locations may be used to determine whether building 600 has tilted in any of the x, y, or z directions.

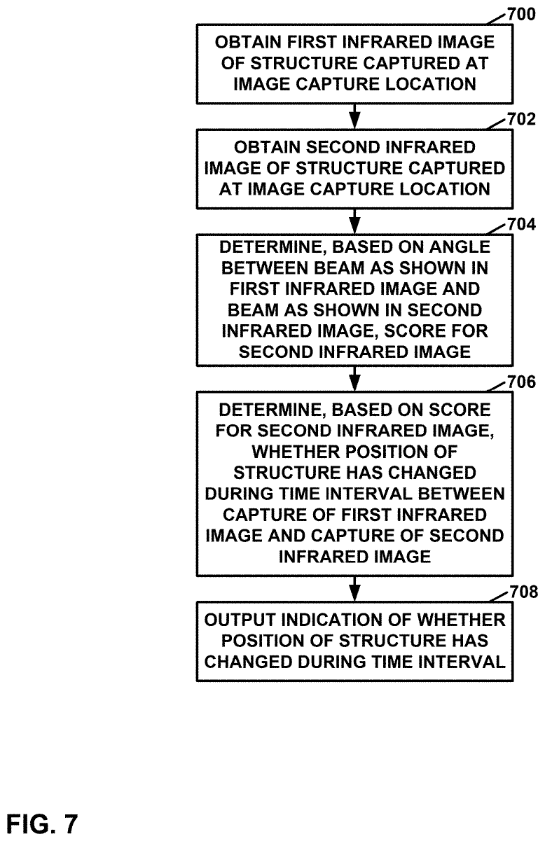

FIG. 7 is a flowchart illustrating an example operation for detecting a position change of a structure, in accordance with a technique of this disclosure. For instance, the operation of FIG. 7 may be used to detect changes in the positions of structure 114 (FIG. 1), structure 200 (FIG. 2), bridge 500 (FIG. 5A and FIG. 5B), and building 600 (FIG. 6).

In the example of FIG. 7, computing system 106 may obtain a first infrared image of the structure captured by a first UAV (e.g., UAV 102 of FIG. 1 and FIG. 3) at an image capture location (700). The image capture location is independent of the structure such that any change in a position of the structure does not change the first location. A beam of a laser attached to the structure is represented in the first infrared image.

Computing system 106 may also obtain a second infrared image of the structure captured by the first UAV or a second UAV at the image capture location after the first infrared image was captured (702). The beam of the laser is also represented in the second infrared image. Computing system 106 may obtain the images in various ways. For example, computing system 106 may retrieve the images from a local or remote image archive, such as image archive 412 (FIG. 4). In some examples, computing system 106 may obtain the images directly from a UAV.

Additionally, computing system 106, may determine based on an angle between the beam from the laser as shown in the first image and the beam from the laser as shown in the second image, a score (e.g., an out-of-phase score) for the second infrared image (704). For example, computing system 106 may determine the score for the second infrared image as being equal to the angle.

In some examples, two laser beams are shown in the first image and the second image. The two laser beams may initially be oriented such that there is a predefined angle between the beams, such as 0° (the beams are parallel), 90° (the beams are orthogonal), or another angle. In such examples, computing system 106 may determine the score for the second image based on an angle between the two laser beams as shown in the second image. For instance, the score may be equal to the angle between the two laser beams as shown in the second image. If the two laser beams no longer have the predefined angle, the angle of one of the laser beams has necessarily changed from the first image to the second image. Thus, a score based on an angle between two laser beams initially having the same predefined angle relative to one another may be equivalent to a score based on an angle between the beam from one of the lasers as shown in the first image and the beam from the laser as shown in the second image.

Furthermore, in the example of FIG. 7, the computing system may determine, based on the score for the second infrared image, whether a position of the structure has changed during a time interval between capture of the first infrared image and capture of the second infrared image (706). For example, the computing system may determine that the position of the structure has changed based on the score for the second image greater than a predefined threshold (e.g., 0.5°, 1°, etc.), that the position of the structure has changed during the time interval. The lasers remain attached to the structure during the time interval and are not moved or rotated relative to the structure.

In some examples, computing system 106 may also obtain a first visible-light image of the structure captured by the first UAV from the image capture location at the same time as the first infrared image was captured. Furthermore, in this example, the computing system may obtain a second visible-light image of the structure captured by the first UAV or the second UAV from the image capture location at the same time as the second infrared image. In this example, if the computing system determines, based on the score for the second infrared image, that the position of the structure has changed during the time interval, a user may use the first and second visible-light images as references to verify that the first and second infrared images are indeed captured from the same location and/or to look for visual evidence that the position of the structure has changed. Furthermore, even if the computing system determines, based on the first and second infrared images, that the position of the structure has not changed, a user or the computing system may check the first and second visible-light images for evidence that the position of the structure has changed. Such evidence may include cracks, spalling, changes in angles or positions of the structure relative to stationary background or foreground objects, and so on. The computing system may be trained (e.g., through a machine learning process) to recognize such evidence. If there is evidence in the second visible-light image that the structure is in need or maintenance, repair, or is fully out of specification, the user or the computing system may classify the second visible-light image as being out-of-spec. Thus, in this way, the computing system may determine, based on the scores for the second set of infrared images and based on visible differences between the first visible-light images and corresponding images in the second set of visible-light images, whether the position of the structure has changed during the time interval between capture of the first set of infrared images and capture of the second set of infrared images.

In some examples, computing system 106 obtains a first set of infrared images captured by the first UAV at a plurality of image capture locations. In this example, the first set of infrared images includes the first infrared image and the image capture location is included in the plurality of image capture locations. Each of the image capture locations may correspond to a GNSS-derived position. Furthermore, in this example, computing system 106 obtains a second set of infrared images captured by the first UAV or the second UAV at the plurality of image capture locations after the first set of infrared images were captured. The second set of infrared images may include the second infrared image. Additionally, in this example, computing system 106 determines, based on angles between beams from a plurality of lasers attached to the structure as shown in corresponding images in the first set of infrared images and the second set of infrared images, scores for the second set of infrared images. As part of determining whether the position of the structure has changed, computing system 106 determines, based on the scores for the second set of infrared images, whether the position of the structure has changed during a time interval between capture of the first set of infrared images and capture of the second set of infrared images. For instance, computing system 106 may determine, based on a percentage of pictures in the second set of pictures having scores above a threshold, that the position of the structure has changed. In some examples, the GNSS-derived positions can be as accurate as within one centimeter.

In some examples, one or more of the lasers attached to the structure include a first laser, a second laser, and a third laser. The first laser, the second laser, and the third laser are attached to the structure such that, at a time of the first set of infrared images were captured, the first laser emits a laser beam in a first direction, the second laser emits a laser beam in a second direction, and the third laser emits a laser beam in a third direction (e.g., x, y, and z directions). In this example, the first direction, the second direction, and the third direction are mutually orthogonal. In some examples, the first direction is parallel to a gravitational vector, such that the second and third directions are orthogonal to the gravitational vector and each other. In some examples, one of the directions (e.g., the first direction) is parallel to a ground slope beneath the structure.

In some examples, computing system 106 also obtain a first set of visible-light images captured by the first UAV at the plurality of image capture locations at the same time as the first set of infrared images. In this example, computing system 106 also obtain a second set of visible-light images captured by the first UAV or the second UAV at the plurality of image capture locations at the same time as the second set of infrared images. Furthermore, in this example, computing system 106 automatically determines or receives an indication of user input specifying whether the second set of visible-light images are out-of-spec. A visible-light image in the second set of visible-light images may be used to re-verify whether the structure is out-of-spec based on whether there are significant visible differences between the visible-light image in the second set of visible-light images and a corresponding image in the first set of visible-light images. Significant visible differences are differences that may be associated with a need for maintenance or repair of the structure. Examples of significant visual differences may include the appearance of or changes in crack lines, improper position of expansion joints, and so on.

The computing system may also output an indication of whether the position of the structure has changed during the time interval (708). For example, the computing system may output an on-screen warning that the position of the structure has changed. In some examples, the computing system may generate an electronic message, such as an e-mail message, indicating that the position of the structure has changed.

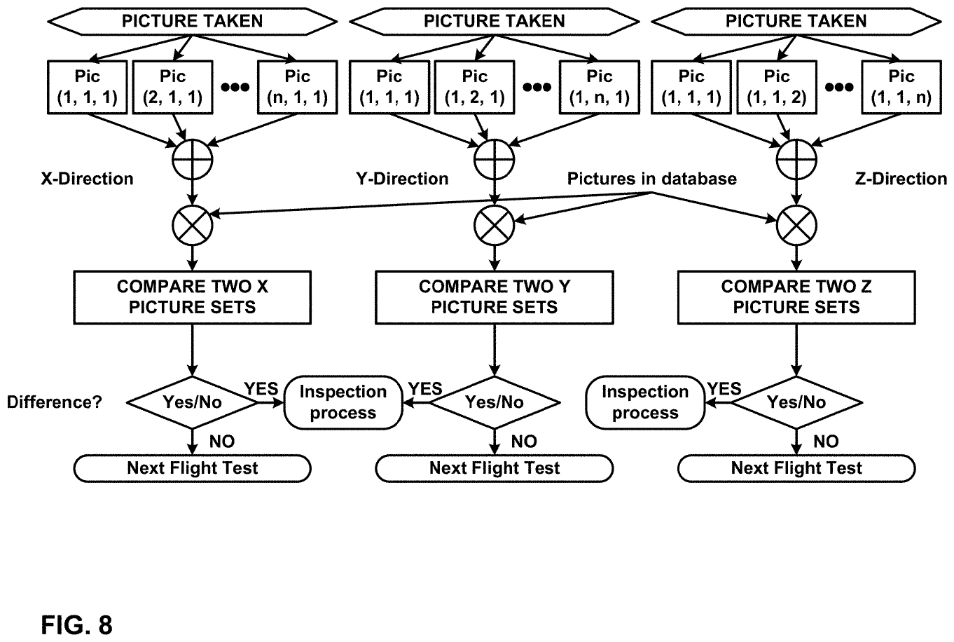

FIG. 8 is a conceptual diagram illustrating a technique for comparing pictures, in accordance with a technique of this disclosure. In the example of FIG. 8, a UAV captures a plurality of images at various image capture locations. The image capture locations are identified by (x, y, and z) coordinates. For example, the UAV may capture images (i.e., take pictures) at locations (1, 1, 1), (2, 1, 1), etc., as shown in the example of FIG. 8, in a single session. The captured images may include x-direction images, y-direction images, and z-direction images. The x-direction images include images that have the same y and z coordinates, but different x coordinates. The y-direction images include images that have the same x and z coordinates, but different y coordinates. The z-direction images include images that have different x and y coordinates, but different z coordinates. The captured images are then stored in a database, as shown by the circles marked with a plus sign. In some examples, the captured images are transferred to a pre-determined cloud server using 3G, 4G, 5G, NBIOT, or another wireless technology for evaluation. Using these two storage techniques may help guarantee safe storage of the captured images.

In the example of FIG. 8, for each image, computing system 106 may retrieve from a database (e.g., image archive 412 (FIG. 4)) images having the same coordinates as the image, but taken at times prior to a time of the session during which the images corresponding to the “PICTURE TAKEN” boxes of FIG. 8 were captured. Retrieval is denoted in FIG. 8 by the circles containing X marks. For example, for an image taken from an image capture location with coordinates (2, 1, 1), computing system 106 may retrieve from the database (which may be located on a cloud server or other location) a historical image taken from the image capture location with coordinates (2, 1, 1). Computing system 106 may then compare the two corresponding images. If there is a significant difference between the corresponding images, an inspection process of the structure may be performed. Otherwise, no further action is taken until a next flight of the UAV to test whether the structure has moved. The inspection process of the structure may be performed in various ways. For example, the inspection process of the structure may be offline, online, or semi-online. When the inspection process is offline, inspection of infrared images and inspection of visible-light images are performed manually. When the inspection process is online, inspection of infrared images and inspection of visible-light images are performed automatically by computing system 106. When the inspection process is semi-online, inspection of infrared images and inspection of visible-light images is performed automatically by computing system 106, but a human worker checks the results of the inspections and provide scheduling of tasks for fixing or maintaining the structure. In the example of FIG. 8, computing system 106 may perform this process for each of the x-direction images, y-direction images, and z-direction images.

FIG. 9 illustrates a decision chart for ground-level movements, in accordance with a technique of this disclosure. Computing system 106 may use such a chart to determine whether a position of a structure has changed. In the example of FIG. 9, a UAV may capture both visual light pictures (i.e., standard pictures) of a structure and infrared images of the structure. Computing system 106 may compare images in a new batch of images of a structure to corresponding images of the structure taken from the same images capture location, as described elsewhere in this disclosure. Analysis of the new batch of images may reveal that only some of the images in the new batch of images show movement of the structure. If the percentage of images showing movement of the structure is sufficiently small, it is likely that the structure has not actually moved. Alternatively, when the percentage of images showing movement of the structure is within particular percentage bands, it may be likely that maintenance or repair is needed on the structure.

In the example of FIG. 9, an image is considered to be “out of spec” if the image shows a sufficiently great discrepancy from corresponding images captured from the same image capture location. For example, an infrared image may be considered to be “out of spec” if an angle between a laser line shown in the infrared image and the laser line in a corresponding infrared image is greater than a particular predefined threshold. In another example, a standard, visible-light image may be considered to be “out of spec” if the image shows differences in inspection targets from one or more corresponding historical visible-light images taken from the same image capture location. Example types of inspection targets may include cracks, spalling, warping or bending of structural elements, debris accumulations (e.g., dust, metal shavings, rust flakes, bird fecal matter), and so on.

Computing system 106 may determine whether the structure is in good condition, whether the structure needs maintenance, whether the structure needs repair, or whether the ground level of the structure is out of specification based the percentage of standard images of the structure are “out of spec” and the percentage of infrared pictures of the structure are “out of spec.” For instance, in the example of FIG. 9, if the number of standard images of the structure that are “out of spec” is less than 2% and the number of infrared images of the structure that are “out of spec” is also less than 2%, then computing system 106 may determine that the structure is in good condition. Similarly, in the example of FIG. 9, if the number of standard images of the structure that are “out of spec” is less than 2% and 2% to 5% of infrared images of the structure that are “out of spec”, computing system 106 may determine that the structure needs maintenance. In other examples, percentages other than those shown in the example of FIG. 9 can be used.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Cloud technology used to automatically save the images on web server is not limited to local or global internet cloud. It can be a private and/or public cloud which is protected by the user ID and passwords. The passwords may not limit to one or two.

Various examples have been described. These and other examples are within the scope of the following claims.

What is claimed is:

1. A method for detecting a position change of a structure, the method comprising:
obtaining, by a computing system, a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image;
obtaining, by the computing system, a second infrared image of the structure captured by the first UAV or a second UAV at the image capture location after the first infrared image was captured, wherein the beam of the laser is represented in the second infrared image;
determining, by the computing system, based on an angle between the beam from the laser as shown in the first image and the beam from the laser as shown in the second image, a score for the second infrared image;
determining, by the computing system, based on the score for the second infrared image, whether a position of the structure has changed during a time interval between capture of the first infrared image and capture of the second infrared image, wherein the laser remains attached to the structure during the time interval; and
outputting, by the computing system, an indication of whether the position of the structure has changed during the time interval.

2. The method of claim 1, wherein the value is a first value, and the method further comprises:
obtaining, by the computing system, a first visible-light image of the structure captured by the first UAV from the image capture location at the same time as the first infrared image was captured; and
obtaining, by the computing system, a second visible-light image of the structure captured by the first UAV or the second UAV from the image capture location at the same time as the second infrared image,
wherein determining whether the position of the structure has changed comprises determining, by the computing system, based on the score for the second infrared picture and based on visible differences between the first visible-light images and corresponding images in the second set of visible-light pictures, whether the position of the structure has changed during the time interval.

3. The method of claim 1, further comprising:
obtaining, by the computing system, a first set of infrared images captured by the first UAV at a plurality of image capture locations, wherein the first set of infrared images includes the first infrared image and the image capture location is included in the plurality of image capture locations;
obtaining, by the computing system, a second set of infrared images captured by the first UAV or the second UAV at the plurality of image capture locations after the first set of infrared images were captured, wherein the second set of infrared images includes the second infrared image; and
determining, by the computing system, based on angles between beams from a plurality of lasers attached to the structure as shown in corresponding images in the first set of infrared images and the second set of infrared images, scores for the second set of infrared images, and
wherein determining whether the position of the structure has changed comprises determining, by the computing system, based on the scores for the second set of infrared images, whether the position of the structure has changed during a time interval between capture of the first set of infrared images and capture of the second set of infrared images.

4. The method of claim 3, wherein determining whether the position of the structure has changed comprises determining, by the computing system, based on a percentage of pictures in the second set of pictures having scores above a threshold, that the position of the structure has changed.

5. The method of claim 3, wherein:
one or more of the lasers attached to the structure include a first laser, a second laser, and a third laser,
the first laser, the second laser, and the third laser are attached to the structure such that, at a time of the first set of infrared images were captured, the first laser emits a laser beam in a first direction, the second laser emits a laser beam in a second direction, and the third laser emits a laser beam in a third direction, and
the first direction, the second direction, and the third direction are mutually orthogonal.

6. The method of claim 5, wherein the first direction is parallel to a gravitational vector.

7. The method of claim 5, wherein the first direction is parallel to a ground slope beneath the structure.

8. The method of claim 3, further comprising:
obtaining, by the computing system, a first set of visible-light images captured by the first UAV at the plurality of image capture locations at the same time as the first set of infrared images; and
obtaining, by the computing system, a second set of visible-light images captured by the first UAV or the second UAV at the plurality of image capture locations at the same time as the second set of infrared images,
wherein determining whether the position of the structure has changed comprises determining, by the computing system, based on the scores for the second set of infrared images and based on visible differences between the first visible-light images and corresponding images in the second set of visible-light images, whether the position of the structure has changed during the time interval between capture of the first set of infrared images and capture of the second set of infrared images.

9. A computing system comprising:
a memory configured to:
store a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image;
store a second infrared image of the structure captured by the first UAV or a second UAV at the image capture location after the first infrared image was captured, wherein the beam of the laser is represented in the second infrared image; and
one or more processing circuits configured to:
determine, based on an angle between the beam from the laser as shown in the first image and the beam from the laser as shown in the second image, a score for the second infrared image;
determine, based on the score for the second infrared image, whether a position of the structure has changed during a time interval between capture of the first infrared image and capture of the second infrared image, wherein the laser remains attached to the structure during the time interval; and
output an indication of whether the position of the structure has changed during the time interval.

10. The computing system of claim 9, wherein the value is a first value, and the one or more processing circuits are further configured to:
obtain a first visible-light image of the structure captured by the first UAV from the image capture location at the same time as the first infrared image was captured; and
obtain a second visible-light image of the structure captured by the first UAV or the second UAV from the image capture location at the same time as the second infrared image,
wherein the one or more processing circuits are configured such that, as part of determining whether the position of the structure has changed, the one or more processing circuits determine, based on the score for the second infrared picture and based on visible differences between the first visible-light images and corresponding images in the second set of visible-light pictures, whether the position of the structure has changed during the time interval.

11. The computing system of claim 9,
wherein the one or more processing circuits are further configured to:
obtain a first set of infrared images captured by the first UAV at a plurality of image capture locations, wherein the first set of infrared images includes the first infrared image and the image capture location is included in the plurality of image capture locations;
obtain a second set of infrared images captured by the first UAV or the second UAV at the plurality of image capture locations after the first set of infrared images were captured, wherein the second set of infrared images includes the second infrared image; and
determine, based on angles between beams from a plurality of lasers attached to the structure as shown in corresponding images in the first set of infrared images and the second set of infrared images, scores for the second set of infrared images, and
wherein the one or more processing circuits are configured such that, as part of determining whether the position of the structure has changed, the one or more processing circuits determine, based on the scores for the second set of infrared images, whether the position of the structure has changed during a time interval between capture of the first set of infrared images and capture of the second set of infrared images.

12. The computing system of claim 11, wherein the one or more processing circuits are configured such that, as part of determining whether the position of the structure has changed, the one or more processing circuits:
determine, based on a percentage of pictures in the second set of pictures having scores above a threshold, that the position of the structure has changed.

13. The computing system of claim 11, wherein:
one or more of the lasers attached to the structure include a first laser, a second laser, and a third laser,
the first laser, the second laser, and the third laser are attached to the structure such that, at a time of the first set of infrared images were captured, the first laser emits a laser beam in a first direction, the second laser emits a laser beam in a second direction, and the third laser emits a laser beam in a third direction, and
the first direction, the second direction, and the third direction are mutually orthogonal.

14. The computing system of claim 13, wherein the first direction is parallel to a gravitational vector.

15. The computing system of claim 13, wherein the first direction is parallel to a ground slope beneath the structure.

16. The computing system of claim 11,
wherein the one or more processing circuits are further configured to:
obtain a first set of visible-light images captured by the first UAV at the plurality of image capture locations at the same time as the first set of infrared images;
obtain a second set of visible-light images captured by the first UAV or the second UAV at the plurality of image capture locations at the same time as the second set of infrared images,
wherein the one or more processing circuits are configured such that, as part of determining whether the position of the structure has changed, the one or more processing circuits determine, based on the scores for the second set of infrared images and based on visible differences between the first visible-light images and corresponding images in the second set of visible-light images, whether the position of the structure has changed during the time interval between capture of the first set of infrared images and capture of the second set of infrared images.

17. A non-transitory computer-readable storage medium having instructions stored thereon that, when executed, cause a computing system to:
obtain a first infrared image of the structure captured by a first unmanned aerial vehicle (UAV) at an image capture location, wherein the image capture location is independent of the structure such that any change in a position of the structure does not change the image capture location, and wherein a beam of a laser attached to the structure is represented in the first infrared image;
obtain a second infrared image of the structure captured by the first UAV or a second UAV at the image capture location after the first infrared image was captured, wherein the beam of the laser is represented in the second infrared image;
determine, based on an angle between the beam from the laser as shown in the first image and the beam from the laser as shown in the second image, a score for the second infrared image;
determine, based on the score for the second infrared image, whether a position of the structure has changed during a time interval between capture of the first infrared image and capture of the second infrared image, wherein the laser remains attached to the structure during the time interval; and
output an indication of whether the position of the structure has changed during the time interval.
